(19) United States
(12) Patent Application Publication
(10) Pub. No.: US 2015/0252832 A1
(43) Pub. Date: Sep. 10, 2015

(54) Fastening System

(71) Applicant: Andries Johannes LE GRANGE, Klerksdorp (ZA)

(72) Inventor: Andries Johannes Le Grange, Klerksdorp (ZA)

(21) Appl. No.: 14/417,496

(22) PCT Filed: Nov. 14, 2012
(86) PCT No.: PCT/ZA2012/000083

§ 371 Date: Jan. 26, 2015

(30) Foreign Application Priority Data
Jul. 9, 2012 (ZA) 2012/05105

(51) Int. Cl. F16B 19/00; F16M 13/02; B65D 63/10

(52) U.S. Cl. CPC F16B 19/00; B65D 63/1063; F16M 13/02

(57) ABSTRACT

Disclosed is a fastening system (10) including an anchor component (12) having a head (16) and an elongate flexible member (18) extending from the head (16). The elongate flexible member (18) has one of the following cross-sections: (i) a circle with at least one segment removed to provide at least one linear cord; (ii) a shape wherein at least three equally spaced arms of the same length radiate radially from the longitudinal axis; or (iii) a polygon made up of linear sections of substantially the same length. At least one series of ratchet formations (22) is provided on a planar surface of the elongate flexible member (18). The fastening system (10) furthermore comprises a push-on fastening component (14) which is separate from, or prior to use severable from, the anchor component (12). The push-on fastening component (14) defines a passageway (42) to receive the elongate flexible member (18) and having at least one ratchet formation engaging member (44) to engage the ratchet formations (22) to allow passage of the elongate flexible member (18) through the passageway (42) in one direction but not in the other direction. The push-on fastening component (14), unlike the anchor component (12), does not include an elongate flexible member with a series of longitudinally arranged ratchet formations.

### BACKGROUND

THIS INVENTION relates to fasteners. In particular, the invention relates to a two-component fastening system, to an anchor component intended for use as part of a two-component fastening system, to a push-on fastening component intended for use as part of a two-component fastening system.

Two-component fastening systems, such as threaded nut-and-bolt fastening systems, and ratchet nut and bolt fastening systems, are well-known in the art. Often, it is necessary to insert a bolt or a similar functional component with an elongate rigid part such as a shank through an aperture or passageway in an object, where access to the aperture from one particular side is restricted thus making it very difficult, if not impossible, to insert the bolt or said similar functional component through the aperture or passageway from said side. A two-component fastening system which addresses at least to some extent this problem would be desirable.

A further drawback of known fastener systems incorporating ratchets is that they either: (i) lack flexibility sufficient to permit the shank to pass through a passageway in an object that is not right circular cylindrical; or (ii) where they are sufficiently flexible, their cross-sectional shape does not facilitate a tight fit between the cross-sectional circular passageway in the object and the shank. It is a further object of this invention to address these drawbacks.

### SUMMARY OF THE INVENTION

According to one aspect of the invention, there is provided a two-component fastening system which includes
an anchor component having:
   a head; and
   an elongate flexible member extending from the head, the elongate flexible member having:
      in section orthogonal to its longitudinal axis one of the following shapes: (i) a circle with at least one segment removed to provide at least one linear cord; (ii) a shape wherein at least three equally spaced arms of the same length radiate radially from the longitudinal axis; or (iii) a polygon made up of linear sections of substantially the same length; and
      at least one series of longitudinally arranged ratchet formations provided on a planar surface of the elongate flexible member; and
a push-on fastening component which is separate from or, prior to use severable from, the anchor component, the push-on fastening component defining a passageway to receive the elongate flexible member and having at least one ratchet formation engaging member to engage the ratchet formations of the elongate flexible member to allow passage of the elongate flexible member through the passageway in one direction but not in an opposite direction, the push-on fastening component, unlike the anchor component, not including an elongate flexible member with a series of longitudinally arranged ratchet formations.

Preferably, the elongate flexible member is in cross-section a polygon comprising linear sections that do not vary in length by more than 15%; more preferably, more than 10% and even more preferably, more than 5%. Optimally, the linear sections of the polygon are of equal length.

Typically, when the elongate flexible member is in cross-section a polygon, the points of intersection of the linear sections define a virtual circle.

Generally, at least one point of intersection of the linear sections lies on each of the three arcs created by dividing the virtual circle's perimeter into three equal lengths.

Preferably, the virtual circle has a diameter between 6 mm and 25 mm.

Optionally, the edges of the polygon are chamfered.

Typically, the elongate flexible member defines at least one groove that extends along the elongate flexible member from the head towards the free end of the elongate flexible member.

Optionally, the at least one series of longitudinally arranged ratchet formations is located within the at least one groove.

Generally, the elongate flexible member is tapered towards its free end.

Preferably, at least a portion of the head extends radially beyond the radial periphery of the flexible member such that, in use, when the elongate flexible member is inserted through an object passageway extending through one or more objects, the oversized head limits insertion of the anchor component through the passageway.

The elongate flexible member may be tapered along its entire length.

Optionally, the elongate flexible member includes a second series of longitudinally arranged ratchet formations. And, the head may be separate from the elongate flexible member, the head defining a passageway to receive the elongate flexible member and having at least one ratchet formation engaging member to engage the second series of ratchet formations of the elongate flexible member to allow passage of the elongate flexible member through the passageway in one direction opposite to the permitted direction of movement of the push-on fastening component along the elongate flexible member, but not in the reverse direction.

In use, in one embodiment of the invention, the elongate flexible member is inserted through an object passageway extending through one or more objects with the head being too large to pass through the object passageway, thus acting as an anchor or stop when a portion of the elongate flexible member remote from the head and protruding from the object passageway is pulled, so that the head remains at one entry into the object passageway and the elongate flexible member projects from another entry into the object passageway.

The head is thus typically larger than the elongate flexible member in at least one direction transverse to the longitudinal axis of the elongate flexible member when the elongate flexible member is pulled straight, so that the head can act as an anchor formation or stop formation on one side of an aperture or passageway through which the elongate flexible member is received. Naturally, as will be appreciated, the anchor component and/or the push-on fastening component may be used with a washer, spring washer or the like to increase the effective size of the component and to distribute pressure.

The head may have a purely functional configuration, e.g. resembling the head of a bolt or screw or similar fastener, or defining a support on which an object can be supported, or defining a hook or an eye, a female fastener formation for receiving a male fastener formation, a male fastener formation to be inserted into a female fastener formation, or any other formation on which an object can be supported, from which an object can be suspended, or to which an object can be attached, mounted, fastened or the like. The head may also be configured to act as an anchor or male body to be embedded in another body, e.g. to act as a solid wall plug to be inserted in a bore drilled into a wall, or to be inserted into a wall plug or the like first inserted into a bore in an object, with the elongate flexible member then extending from the embedded portion of the head.

Instead, the head may be decorative, e.g. defining an ornamental feature intended to be mounted against a surface.

The head may also be both functional and decorative, e.g. when the head is intended to function as a doorknob, ornamental hook, ornamental support for a shelf, or the like.

In one embodiment of the invention, the head includes or defines a formation selected from the group consisting of an anchor or stop formation, a formation resembling the head of a bolt or screw or similar fastener, a support formation on which an object can be supported, a hook formation, an eye formation, a female fastener formation for receiving a male fastener formation, a male fastener formation to be inserted into a female fastener formation, an anchor formation or male body to be embedded in another body, an ornamental formation, a doorknob, or combinations of two or more of these.

In another embodiment of the invention, the head includes or defines a formation selected from the group consisting of a stop formation, a formation resembling the head of a bolt or screw, a support formation on which an object can be supported, a hook formation, an eye formation, a female fastener formation for receiving a male fastener formation, a male fastener formation to be inserted into a female fastener formation, an anchor formation or male body to be embedded in another body, a doorknob, or combinations of two or more of these.

In yet another embodiment of the invention, the head includes or defines a formation selected from the group consisting of a formation resembling the head of a bolt or screw, a hook formation, a male fastener formation to be inserted into a female fastener formation, a male body to be embedded in another body, a doorknob, or combinations of two or more of these.

The head may include a body defining a recessed or depressed surface from which the elongate flexible member extends.

The body of the head may thus define an abutment surface or abutment formations abutting in use against an object or a surface against which the head is pulled once the push-on fastening component has been used to fasten the anchor component and the push-on fastening component together, with the elongate flexible member extending between the head and the push-on fastening component being under tension. The abutment surface or abutment formations may surround the elongate flexible member where the elongate flexible member extends from the head.

Typically, when the body of the head defines a peripheral abutment surface, the peripheral abutment surface is planar and preferably endless.

Preferably, when the body of the head defines abutment formations, the abutment formations are equiangularly spaced about the elongate flexible member.

The head, or at least the body of the head and the elongate flexible member may be separately manufactured parts that are connected together.

The head, or at least the body of the head and the elongate flexible member may be of the same material of construction, or may be of different materials of construction.

Instead of being separately manufactured parts, the head, or at least the body of the head and the elongate flexible member may be integrally manufactured, e.g. integrally moulded. Typically, in this case, the head, or at least the body of the head and the elongate flexible member are of the same material of construction.

The head may also include or define a head passageway to receive the elongate flexible member, so that the elongate flexible member can in use be looped around an object and passed through the head passageway. The head may also include at least one ratchet formation engaging member to engage the ratchet formations of the flexible member so that the anchor component can function on its own like the well-known cable-tie. It is however envisaged that this will be a less common embodiment of the anchor component and that the head will thus typically not include a head passageway for the flexible member or a ratchet formation engaging member.

The elongate flexible member is typically cylindrical over at least a major portion of the length of the elongate flexible member when pulled straight and may be of any desired cross-section, e.g. square, triangular, circular, or rectangular. Preferably however, the elongate flexible member has at least one longitudinally extending planar surface when the elongate flexible member is pulled straight, with the series of ratchet formations being arranged on said planar surface.

The elongate flexible member may be in the form of a strap with a generally rectangular cross section taken in a plane transversely to the longitudinal axis of the strap when the strap is flattened on a planar surface.

In one embodiment of the invention, the elongate flexible member is in the form of a strap, with two series of ratchet formations respectively being arranged on two opposed major surfaces of the strap, with two opposed minor surfaces of the strap defining sides of the strap extending between the two major surfaces of the strap. Typically, the minor surfaces are free of ratchet formations and are preferable smooth. The minor surfaces may be curved or, instead, may be planar.

In another embodiment of the invention, the elongate flexible member is circular in transverse cross section, with at least one segment of the circle removed to define a longitudinally extending planar surface when the elongate flexible member is pulled straight.

In another embodiment of the invention, the elongate flexible member is circular in transverse cross section, with at least two segments of the circle removed to define two longitudinally extending planar surfaces when the elongate flexible member is pulled straight. The two segments are preferably diagonally opposed so that the two longitudinally extending planar surfaces are opposed and in parallel planes when the elongate flexible member is pulled straight.

The elongate flexible member may be of metal, e.g. steel, stainless steel, zinc-coated stainless steel, or zinc-coated steel. Instead, the elongate flexible member may be of a synthetic plastics or polymeric material, e.g. a polyamide such as nylon or nylon 6.6, ethylene tetrafluoroethylene, ethylene chlorotrifluoroethylene, or polyvinylchloride.

Advantageously, an elongate flexible member of a synthetic plastics or polymeric material can more easily be severed, to remove a free end portion projecting from the push-on fastening component, once the push-on fastening component has been fastened to the elongate flexible member, than an elongate flexible member of a more difficult to sever material, such as steel. However, an elongate flexible member of a stronger material, such as steel, can handle higher tensile forces and can have stronger ratchet formations.

Typically, the elongate flexible member is dimensioned such that it can be passed longitudinally through an aperture or passageway with a bore of up to about 25 mm, e.g. between 6 mm and 25 mm in diameter.

The push-on fastening component may include a body of any desired shape, with the passageway extending through the body. Typically, the passageway of the push-on fastening component extends centrally through the body.

The at least one ratchet formation engaging member may be in the form of a pawl positioned to engage the ratchet formations of an elongate flexible member of an anchor component inserted through the passageway of the push-on fastening component. Ratchet formation engaging members and ratchet formations, e.g. as used in cable-ties, are however well-known in the art and it is to be appreciated that there are many combinations of shapes and configurations that can be used for the ratchet formations of the elongate flexible member and the ratchet formation engaging member of the push-on fastening component, all falling within the scope of the invention.

The push-on fastening component, or at least the body of the push-on fastening component, may be of a metal or of a synthetic plastics or polymeric material, or of a combination of metal and a synthetic plastics or polymeric material. For example, the push-on fastening component may include a body of a synthetic plastics or polymeric material, such as nylon, nylon 6.6, ethylene tetrafluoroethylene, ethylene chlorotrifluoroethylene, or polyvinyl chloride, and a metal pawl. In some embodiments of the invention, the pawl may also be of a synthetic plastics or polymeric material and the body of the push-on fastening component and the pawl may be integrally moulded.

The push-on fastening component may include a release mechanism for the ratchet formation engaging member. Release mechanisms for cable ties are for example described in U.S. Pat. No. 6,185,791, U.S. Pat. No. 5,193,250 and U.S. Pat. No. 3,991,444. Release mechanisms for cable-ties are thus well-known to those skilled in the art, can be used as such in the push-on fastener of the invention and do not require further description herein.

The anchor component and the push-on fastening component may be integrally moulded together from a synthetic plastics or polymeric material and may be connected by a severable bridge portion, so that the fastening system is provided or packaged as a unitary item. The bridge portion may include a zone of weakness or frangible line. Prior to use, the anchor component and the fastening component are then separated, e.g. by breaking the bridge portion by twisting, or by severing the bridge portion with a knife or cutting pliers or the like, providing a functional two-component fastening system in accordance with the invention.

The body of the push-on fastening component may define an abutment surface or abutment formations abutting in use against a surface or object from which the elongate flexible member of the anchor component projects, once the push-on fastening component has been used to fasten the anchor component and the push-on fastening component together, with the elongate flexible member extending between the head and the push-on fastening component being under tension. The abutment surface or abutment formations may surround the passageway of the push-on fastening component.

Typically, when the body of the push-on fastening component defines a peripheral abutment surface, the peripheral abutment surface is planar and preferably endless.

Preferably, when the body of the push-on fastening component defines abutment formations, the abutment formations are equiangularly spaced about the passageway of the push-on or second fastening component.

The body of the push-on fastening component may define a recessed or depressed surface, surrounded by the abutment surface or the abutment formations of the body of the push-on fastening component, with the passageway of the push-on fastening component opening out in the recessed or depressed surface, e.g. centrally in the recessed or depressed surface.

According to another aspect of the invention, there is provided an anchor component intended for use as part of a two-component fastening system, the anchor component including a head and an elongate flexible member extending from the head, the flexible member having at least one series of longitudinally arranged ratchet formations and the head having a body which defines an abutment surface which surrounds the elongate flexible member where the elongate flexible member extends from the head.

The anchor component may be as hereinbefore described.

According to a further aspect of the invention, there is provided a push-on fastening component intended for use as part of a two-component fastening system, the push-on fastening component including or defining a passageway to receive an elongate flexible member having at least one series of longitudinally arranged ratchet formations, the push-on fastening component further including at least one ratchet formation engaging member to engage the ratchet formations of the elongate flexible member to allow passage of the elongate flexible member through the passageway in one direction but not in an opposite direction, the push-on fastening component not including an elongate flexible member with a series of longitudinally arranged ratchet formations.

The push-on fastening component may be as hereinbefore described.

The invention extends to a method of fastening using a two-component fastening system, the method including:
passing the elongate flexible member of an anchor component as hereinbefore described through an object passageway extending through at least one object so that an exposed free end portion of the elongate flexible member remote from the head of the anchor component protrudes from the object passageway; and
pushing a push-on fastener as hereinbefore described over the exposed free end portion with the exposed free end portion of the elongate flexible member being received in the passageway of the push-on fastening component and with the ratchet formation engaging formation of the push-on fastening component engaging the ratchet formations of the flexible member to prevent withdrawal of the exposed free end portion of the elongate flexible member from the passageway of the push-on fastening component.

The method may include pushing the elongate flexible member through the passageway of the push-on fastening component so that an end portion of the elongate flexible member protrudes from the passageway of the push-on fastening component, and pulling on the free end portion, or pushing against the head, to seat the head of the anchor component against said at least one object, whilst pushing the push-on fastener as far along the elongate flexible member as it can move, thereby locking the push-on fastener to the elongate flexible member.

The method may include maintaining a pulling force on the elongate flexible member whilst pushing the push-on fastener as far along the elongate flexible member as it can move, thereby locking the push-on fastener to the elongate flexible member by means of at least one of said ratchet formations and said at least one ratchet formation engaging member, with the elongate flexible member being under tension.

The method may include severing a portion of the elongate flexible member protruding from the passageway of the push-on fastening component, after locking the push-on fastener to the elongate flexible member by means of at least one of said ratchet formations and said at least one ratchet formation engaging member.

### BRIEF DESCRIPTION OF THE DRAWINGS

The invention will now be described in more detail, by way of examples only, with reference to the accompanying drawings in which:

FIG. 1 shows a three-dimensional view of a two-component fastening system in accordance with the invention which includes an anchor component and a push-on fastening component;

FIG. 2 shows a sectioned view of the components of the two-component fastening system of FIG. 1, taken at II-II in FIG. 1;

FIG. 3 shows a side view of another embodiment of an anchor component of a two-component fastening system in accordance with the invention;

FIG. 4 shows a side view of a further embodiment of an anchor component of a two-component fastening system in accordance with the invention;

FIG. 5 shows a side view of yet another embodiment of an anchor component of a two-component fastening system in accordance with the invention;

FIG. 6 shows a side view of still another embodiment of an anchor component of a two-component fastening system in accordance with the invention;

FIG. 7 shows a side view of yet a further embodiment of an anchor component of a two-component fastening system in accordance with the invention;

FIG. 8 shows a three-dimensional view of another embodiment of an anchor component of a two-component fastening system in accordance with the invention;

FIG. 9 shows a three-dimensional view of another embodiment of an anchor component of a two-component fastening system in accordance with the invention;

FIG. 10 shows a side view of still a further embodiment of an anchor component of a two-component fastening system in accordance with the invention;

FIG. 11 shows a bottom view of yet a further embodiment of an anchor component of a two-component fastening system in accordance with the invention;

FIG. 12 shows a sectioned view of the anchor component of FIG. 11;

FIG. 13 shows one embodiment of a two-component fastening system in accordance with the invention manufactured for packaging as a unitary product;

FIG. 14 shows a three-dimensional view of another embodiment of a push-on fastening component of a two-component fastening system in accordance with the invention;

FIG. 15 shows a further sectioned view of the push-on fastening component of FIG. 1, taken at XV-XV in FIG. 1;

FIG. 16 shows one application of the two-component fastening system of the invention to fasten two objects together;

FIG. 17 shows one application of the two-component fastening system of the invention to provide a door knob;

FIG. 18 shows one application of the two-component fastening system of the invention to anchor a strap which can then be used in combination with a push-on fastening component to mount or fasten another object;

FIG. 19 shows a three-dimensional view of an alternative embodiment of a two-component fastening system in accordance with the invention, comprising a square cross-sectional anchor component and a push-on fastening component;

FIG. 20 shows an end view of each of the anchor component and the push-on fastening component of the two-component fastening system in FIG. 19;

FIG. 21 shows a three-dimensional view of a further alternative embodiment of a two-component fastening system in accordance with the invention, comprising a triangular cross-sectional anchor component and a push-on fastening component;

FIG. 22 shows an end view of each of the anchor component and the push-on fastening component of the two-component fastening system in FIG. 21;

FIG. 23 shows a three dimensional view of a fifteenth embodiment of a two-component fastening system in accordance with the invention which includes a tapered anchor component and a push-on fastening component; and

FIG. 24 shows an end view of each of the anchor component and the push-on fastening component of the two-component fastening system in FIG. 23.

### DESCRIPTION OF EMBODIMENTS OF THE INVENTION

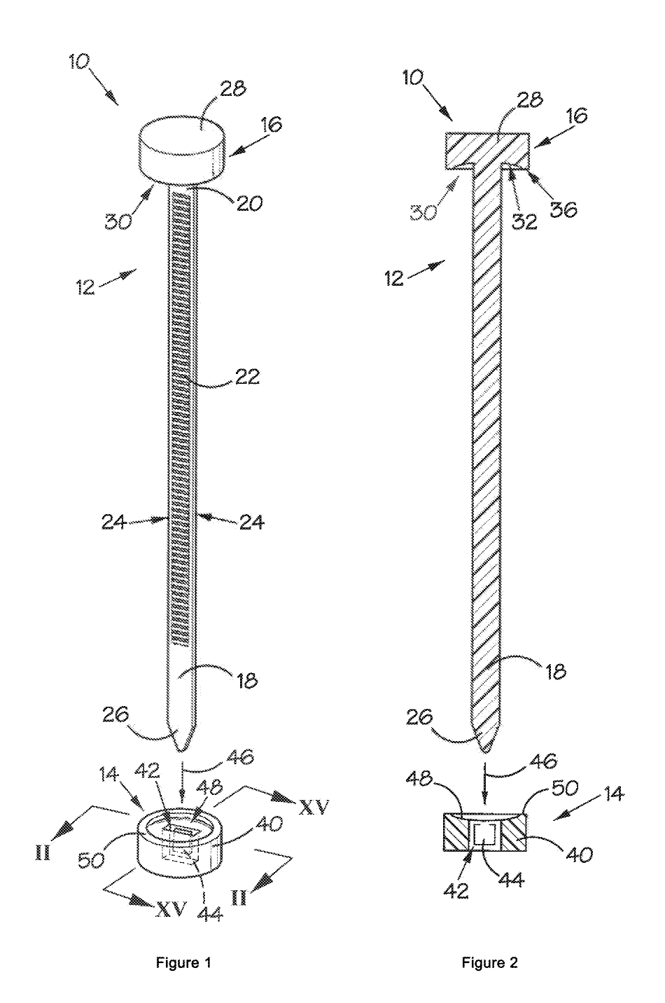

Referring to FIGS. 1 and 13 of the drawings, reference numeral 10 generally indicates a two-component fastening system in accordance with the invention. The system 10 includes an anchor component 12 and a push-on fastening component 14.

In the embodiment of the two-component fastening system shown in FIG. 1 of the drawings, the anchor component 12 includes a solid head 16 of nylon 6.6 integrally moulded with an elongate flexible member in the form of a solid strap 18, also of nylon 6.6.

The strap 18 extends centrally from a bottom of the head 16 and resembles the strap of a conventional cable tie. Thus, the strap 18 has opposed major faces 20 (which are planar when the strap 18 is pulled straight or flattened in another way) with a series of ratchet formations 22 arranged longitudinally along the length of the strap 18, on the major faces 20. Minor faces 24 form sides of the strap 18, extend between the major faces 20 and are smooth. In the embodiment shown in FIG. 1, the minor faces 24 are flat. A free end portion of the strap 18, remote from the head 16, is free of ratchet formations 22 and tapers to a point 26 to facilitate insertion of the free end portion into a passageway, bore or the like.

Advantageously, being of nylon 6.6 or, in other embodiments of the invention, of another synthetic plastics or polymeric material, the strap 18 can easily be severed. If however it is desirable to have a stronger strap 18, the strap 18 can be of a metal such as steel, stainless steel or zinc-coated steel.

The head 16 comprises a body 28 with a circular bottom surface 30 from which the strap 18 extends centrally. In one embodiment of the invention, as illustrated in FIG. 2 of the drawings, the body 28 defines a recessed or depressed surface 32 centrally within the bottom surface 30, so that the depressed surface 32 typically has a circular periphery, with the elongate flexible member or strap 18 extending centrally from the depressed surface 32.

In another embodiment, as illustrated in FIG. 11, the body 28 defines a plurality of abutment formations 34 surrounding the strap 18 and projecting above the surface 30. The abutment formations 34, in the embodiment illustrated in FIG. 11, are spaced from the strap 18, arranged in a circle and are equiangularly disposed.

FIG. 11 also illustrates another embodiment of the strap 18. The strap 18 shown in FIG. 11 is circular in transverse cross section (or in end view as shown in FIG. 11), with two diagonally opposed segments of the circle removed to define two longitudinally extending planar faces 20 in parallel planes when the strap 18 is pulled straight. The ratchet formations (not visible in FIG. 11) are then of course located on the faces 20.

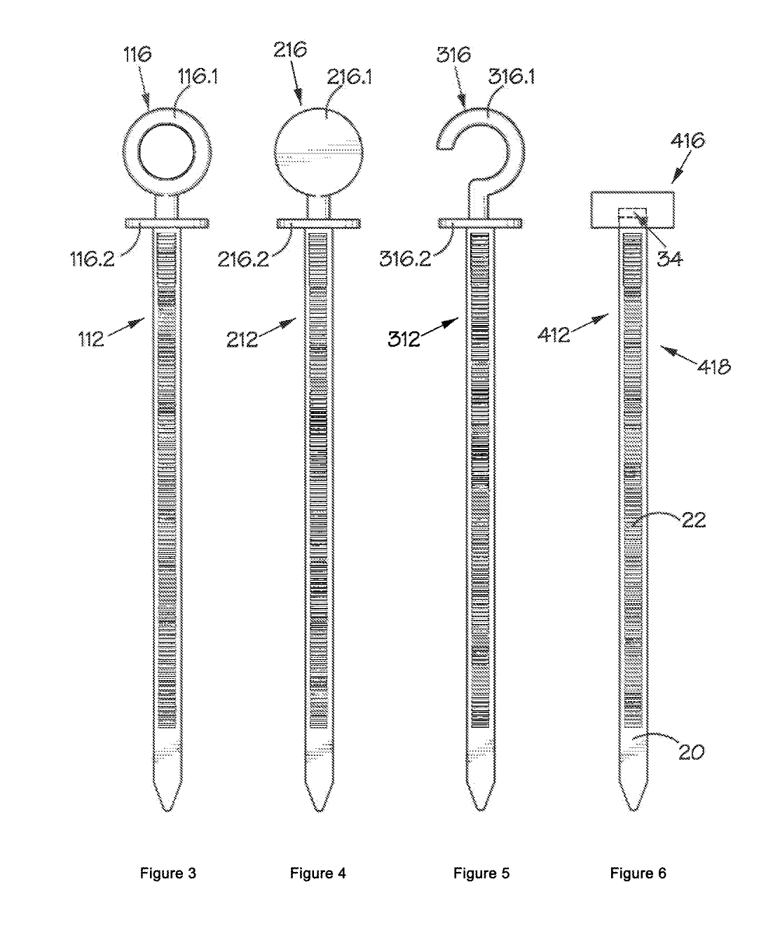

In the embodiment illustrated in FIG. 1, the head 16 has a simple disc-like shape which is both aesthetically pleasing and which functions well as an anchor or stop (with or without the use of a washer) when the strap 18 is inserted through a passageway in one or more objects. As illustrated in FIGS. 3 to 10, the head of the anchor component of the two-component fastening system of the invention can take on many embodiments, some of which are purely functional, and some of which are both functional and decorative.

As shown in FIG. 3, a head 116 of an anchor component 112 defines an eye 116.1 and a circular or disk-shaped flange 116.2.

With reference to FIG. 4, it is shown that a head 216 of an anchor component 212 defines a door knob 216.1 and a circular or disk-shaped flange 216.2.

FIG. 5 illustrates how a head 316 of an anchor component 312 defines a hook 316.1 and a circular or disk-shaped flange 316.2.

In FIG. 6, a head 416 of an anchor component 412 defines a head passageway 34 which extends through the head 416, in a direction transverse to an elongate flexible member or strap 418. The strap 418 has ratchet formations 22 on one face 20 only, with the opposed face 20 being smooth. An opening or mouth of the head passageway 34 faces in the same directions as the face 20 on which the ratchet formations 22 are located. A ratchet formation engaging member, in the form of a pawl (not clearly visible) is located inside the head passageway 34 allowing the anchor component 412 illustrated in FIG. 6 to function as a cable tie.

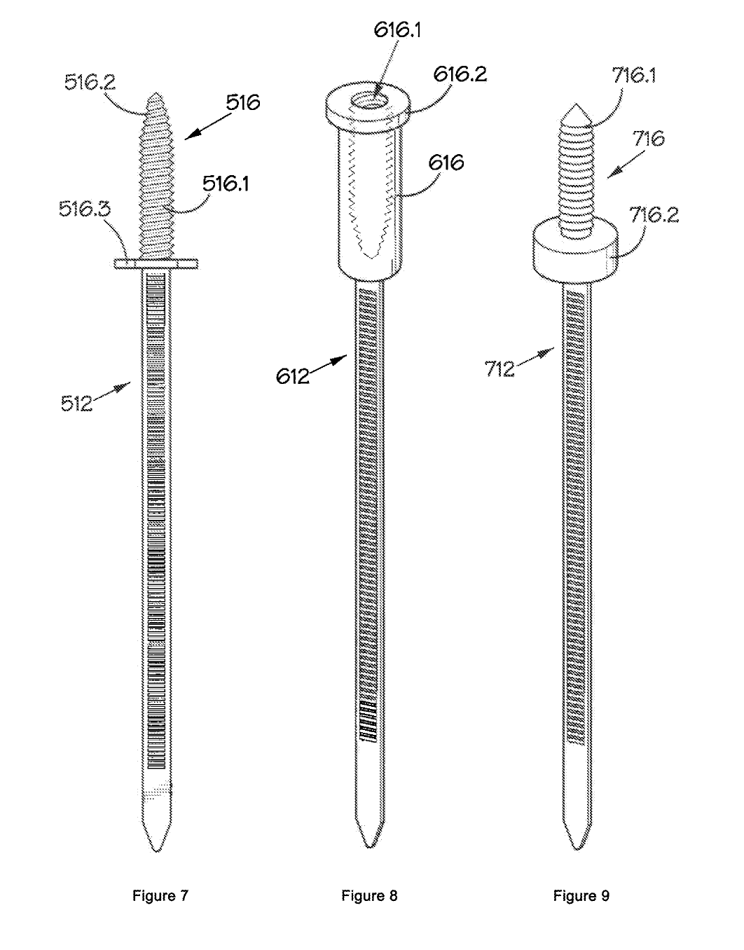

As illustrated in FIG. 7, a head 516 of an anchor component 512 has an elongate portion 516.1 with a screw thread 516.2 and a hexagonal flange 516.3. The head 516 shown in

FIG. 7 can thus function as an anchor or male body to be embedded in another object by being screwed into a bore drilled into said another object, or by being screwed into an object or fastener such as a wall plug, screw anchor, dowel or the like, by means of a wrench.

FIG. 8 illustrates how a head 616 of an anchor component 612 defines a female fastener formation or socket 616.1 for receiving a male fastener formation (not shown). An annular flange 616.2 is also defined by the head 616 for abutting against a surface of an object such as a drywall panel within which the head 16 is embedded or inserted in use.

FIG. 9 illustrates how a head 716 of an anchor component 712 defines a male fastener formation 716.1 intended to be inserted with a friction fit into a female fastener formation or socket (not shown). An annular flange 716.2 is also defined by the head 716 for abutting against a surface of an object such as a drywall panel or a wall plug defining a socket formation, within which the head 716 is embedded or inserted in use.

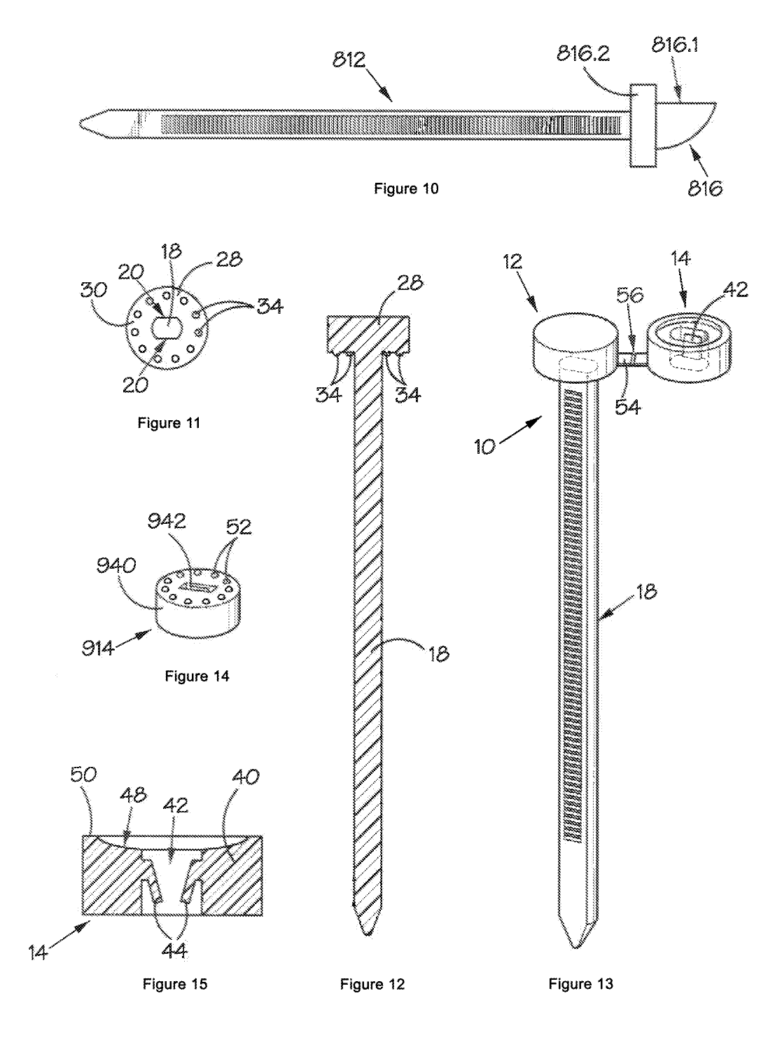

FIG. 10 illustrates how a head 816 of an anchor component 812 defines a support with a flange 816.2 and a support surface 816.1 for supporting an object such as a shelf.

In the embodiment illustrated in FIGS. 1 and 2, the head 16 defines an endless, annular peripheral abutment surface 36 encircling the strap 18. The abutment surface 36 is planar to assist in seating neatly against a flat surface.

The push-on fastening component 14 includes a body 40 defining a central passageway 42 shaped and dimensioned to receive the strap 18 of the anchor component 12. The passageway 42 is thus rectangular in transverse cross section and extends through the body 40.

A pair of opposed ratchet formation engaging members, in the form of pawls 44 (only one of which is shown in FIG. 1 and FIG. 13 for clarity and only one of which is visible in the sectioned view of FIG. 2) are located inside the passageway 42 to engage the ratchet formations 22 of the strap 18 thereby to allow passage of the strap 18 through the passageway 42 in one direction only, indicated by an arrow 46 but not in an opposite direction. The use of ratchet formation engaging members such as the pawls 44 in cable ties is well-known and the ratchet formation engaging members or pawls 44 of the push-on fastening component 14 can function in exactly the same way as that of a cable tie. The ratchet formation engaging members or pawls 44 may thus be integrally moulded with the body 40, e.g. of nylon 6.6, or they may be metal components inserted into and attached to the body 40. Although not shown in the drawings, the push-on fastening component 14 may also be provided with one or more release mechanisms for the ratchet formation engaging members or pawls 44 so that withdrawal of a strap 18 in a direction opposite to the arrow 46 indeed becomes possible.

In the embodiment of the push-on fastening component 14 illustrated in FIGS. 1 and 2, the body 40 defines a centrally located recessed or depressed surface 48, surrounded by an abutment surface 50 which is annular and thus endless, and which is planar. The passageway 42 is located centrally within the depressed surface 48.

Instead of defining an annular abutment surface 50, in another embodiment of the push-on fastening component of the invention indicated by reference numeral 914 in FIG. 14 of the drawings, a body 940 of the push-on component 914 includes or defines a plurality of abutment formations 52 as shown in FIG. 14 of the drawings. The abutment formations 52 are equiangularly spaced about a passageway 942 and are arranged in a circle, in the embodiment illustrated in FIG. 14.

Although the system 10 can be supplied with the anchor component 12 et al. and the push-on fastening component 14, 914 as separate components, it is envisaged that the system 10 can also be supplied with the anchor component 12 et al. and the push-on fastening component 14, 914 being attached initially for later separation. Thus, the anchor component 12 et al. and the push-on fastening component 14, 914 may be integrally moulded together from a synthetic plastics or polymeric material, being connected by a bridge portion 54 as shown in FIG. 13 of the drawings. The bridge portion 54 preferably can easily be severed. The bridge portion 54 thus may have one or more zones of weakness 56 allowing easy separation of the anchor component 12 and the push-on fastening component 14. Instead, one can simply cut the bridge portion 54 with a knife or cutting pliers or the like to separate the components 12, 14.

The anchor component 12 shown in FIG. 13 has the same strap 18 as shown in FIG. 11. The passageway 42 in the push-on fastening component 14 shown in FIG. 13 is shaped complementary to the cross-sectional profile of the strap 18 shown in FIG. 13. It is expected that the strap 18 shown in FIG. 11 and FIG. 13 will be a preferred embodiment of the elongate flexible member of the anchor component of the invention, as it better fills a circular bore drilled through an object. Possible even more preferred if a single series of ratchet formations is adequate or would suffice, would be a strap which is circular in transverse cross section or end view, with only one longitudinally extending flat face carrying ratchet formations (i.e. circular in transverse section with only a single segment of the circle removed).

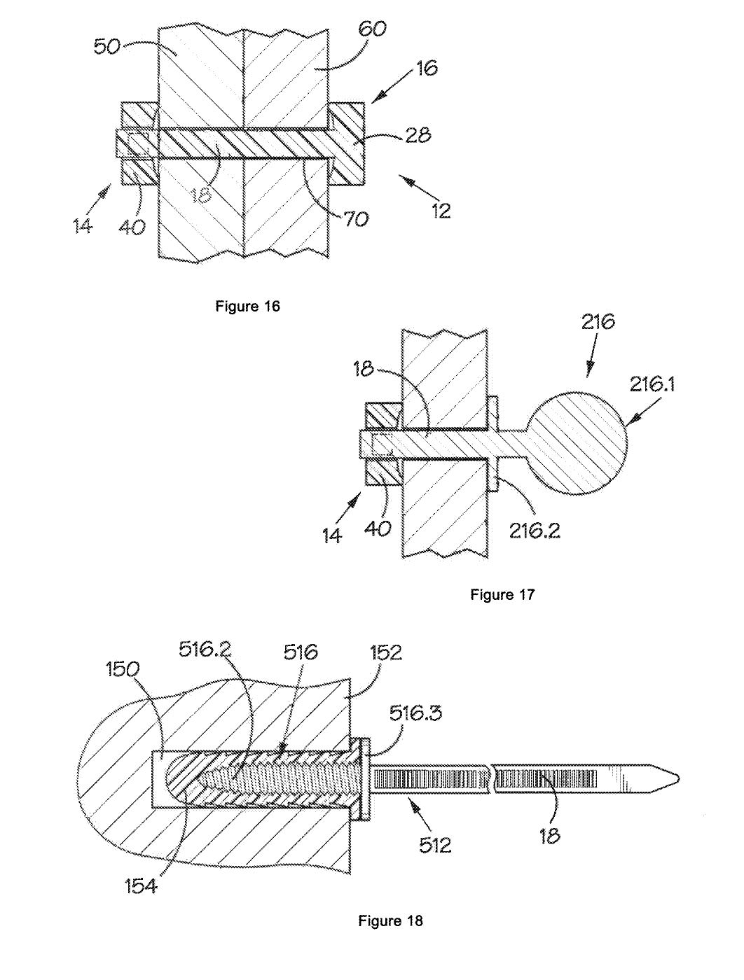

The two-component fastening system 10 of the invention is simple to use. The system 10 can for example be used to fasten two objects 50, 60 together as shown in FIG. 16. In this application of the two-component fastening system of the invention, the elongate flexible member or strap 18 of the anchor component 12 is inserted or threaded through a passageway 70 extending through the objects 50,60 so that an exposed free end portion of the strap 18 remote from the head 16 protrudes from the passageway. The push-on fastening component is pushed over the strap 18 so that the strap 18 passes through the passageway 42 in the body 40 in the direction of arrow 46 (see FIG. 1). By means of the exposed portion of the strap 18 protruding from the body 40, the head 16 is pulled tightly against the object 60 against which the head 16 abuts and the push-on fastening component 14 is pushed towards the head 16 as far as it can go until it abuts against the object 50, with the ratchet formation engaging members or pawls 44 preventing withdrawal of the push-on fastening component 14, thereby locking or fastening the objects 50, 60 together, as shown in FIG. 16. If desired, as shown in FIG. 16, a free end portion of the strap 18 projecting from the body 40 of the push-on fastening component 14 can then be severed, e.g. with a knife or cutting pliers, so that the strap 18 is more or less flush with the body 40 of the push-on fastening component 14.

Advantageously, when the body 28 and/or the body 40 defines a depressed surface 32 or 48, the head 16 and the body 40, being of a somewhat resiliently deformable plastics material, can be forced closer together by taking up some of the space provided by the depressed surface 32 and/or 48 (e.g. by pulling on the strap 18 so that the head 28 deforms in the direction of the pulling force exerted by the strap 18, and by pushing against the body 40 so that the body 40 deforms towards the object 50), with some bias being created by one or both of the head 16 or the body 40 so that, after the ratchet formation engaging members or pawls 44 have locked, the strap 18 is under tension. The same advantage is provided when abutment formations such as the abutment formations 34, 54 are present.

If the system 10 is intended to be used merely to mount the head 16, 116 et al. and not to fasten two or more objects together, a similar procedure is used. As will however be appreciated, a single object will be present with an object passageway through which the strap 18 is then threaded with the head 16, 116 et al. and the body 40, 940 abutting against opposed surfaces of said object once the anchor component 12, 112 et al and the push-on fastening component 14, 914 have been locked together. This will typically be the situation when the head is in the form of a purely ornamental or decorative article or in the form of a door knob, as shown in FIG. 17, an eye, a hook, a shelf support, a female mounting formation, a male mounting formation, an anchor or male body to be embedded in another object (as shown in FIG. 18), or the like.

The fastening system 10, as illustrated in FIG. 7, can also be used as a way of anchoring a strap 18 without having to drill a passageway right through an object. In this embodiment of the invention, as illustrated in FIG. 18, a bore 150 is drilled into an object such as a wall 152 and a head 516 with a screw thread 516.2, e.g. as illustrated in FIG. 7, is screwed into the bore 150 (if necessary making use of a wall plug 154 or the like as shown in FIG. 18) so that the strap 18 extends away from the wall 152 and hangs from the head 516. The strap 18 and a push-on fastening component 14, 914 can then be used to mount or fasten an object against the surface of the object into which the bore 150 was drilled, e.g. against the surface of the wall 152.

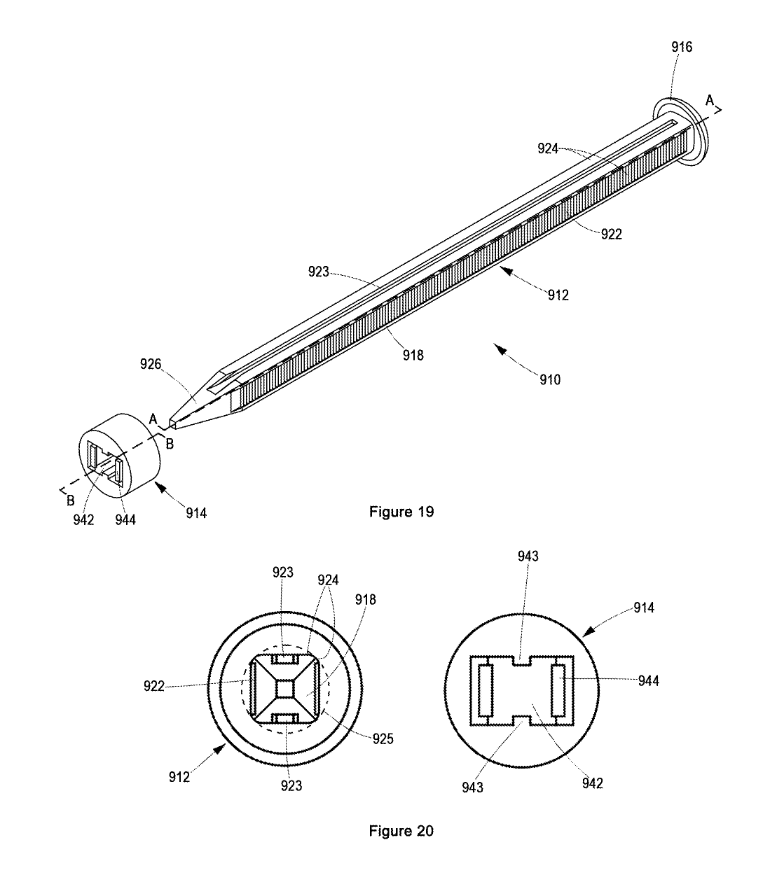

Alternative embodiments of the two-component fastening system 910 according to the present invention are illustrated in FIGS. 19 to 22.

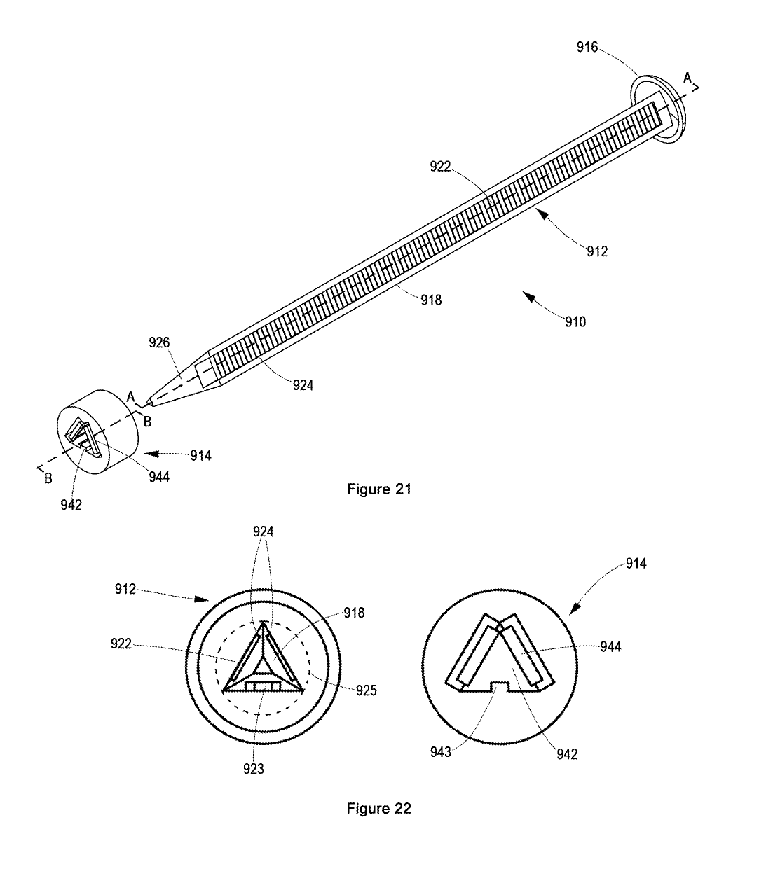

FIGS. 19 and 20 show an anchor component 912 having an elongate flexible member 918 extending from the head 916, which elongate flexible member 918 is square in cross section (i.e. in a plane orthogonal to its longitudinal axis A-A), whereas FIGS. 21 and 22 show an anchor component 912 having a elongate flexible member 918 that is equilateral triangular in cross section.

The push-on fastener component 914 of both of these alternative embodiments defines axially extending bores 942 that are sized and shaped (i.e. being square or equilateral triangular in a plane orthogonal to their longitudinal axes B-B) to receive the corresponding elongate flexible members 918 therein.

Ratchet formations 922 and pawls 944 (as previously described) are included on at least a portion of the peripheral surface of the elongate flexible members 918 and on the push-on fastener components 914, respectively.

Each elongate flexible member 918 is tapered at its free end 926 and defines at least one linear groove 923 that runs axially along the elongate flexible member from the head 916 towards the tapered free end 926. Since the radial distance between the bottom of the groove 923 and the longitudinal axis A-A of the elongate flexible member 918 is constant, the groove terminates short of the tapered free end 926. Preferably, as shown in FIGS. 19 and 20, each elongate flexible member 918 includes two grooves 923. In this arrangement, the square cross-sectional shape and the opposing grooves 923 cause the elongate flexible member 918 to resemble an H-shape in cross section.

Although not shown, it will be appreciated that the ratchet formations 922 could be located on the bottom of the grooves 923.

Each push-on fastener component 914 includes at least one tab 943 that extend into the bore 942, the tab 943 being sized and shaped to correspond with the groove 923 so as to be locatable therein and slidable therealong when the push-on fastener component 914 is located on the elongate flexible member 918.

Importantly, the extreme radial points on the square and equilateral triangular cross sectional elongate flexible members 918 define a virtual circle 925. This ensures that the elongate flexible members 918 can be threaded with little “play”/with a tight “fit” through circular bores/passageways extending through objects having an inside diameter only slightly greater than the diameter of the virtual circle 925.

It will also be appreciated that the cross sectional shape of the elongate flexible members 918 could alternatively be: (i) circular with at leat one segment removed to provide at least one linear cord; (ii) of a shape wherein at least three equally spaced arms of the same length radiate radially from the axis A-A of the elongate flexible member 918; or (iii) any other polygon in shape (e.g. hexagon, octagon, etc.), provided that each face 924 of the elongate flexible member 918 is substantially of equal length so as to ensure that the points of intersection between the faces 924 lie on the virtual circle 925. In essence, the points of intersection between the faces 924 should be spaced angularly substantially equally about the longitudinal axis A-A of the elongate flexible member 918. In the circumstances: (i) “substantially of equal length” should be interpreted to mean that the length of the faces 924 do not differ by more than 15%, preferably, by not more than 10%, even more preferably, by not more than 5%; and (ii) “substantially equally spaced” should be interpreted to mean that the angular spacing between each point of intersection about the longitudinal axis A-A of the elongate flexible member 918 should not differ by more than 15%, preferably, by not more than 10%, even more preferably, by not more than 5%. Optimally, the length of the faces 924 are equal, and the points of intersection of the faces 924 are equiangularly spaced about the longitudinal axis A-A of the elongate flexible member.

When polygonal in cross-sectional shape, at least three points of intersection between faces 924 on the elongate flexible member 918 must be substantially equally spaced about the longitudinal axis A-A of the elongate flexible member 918, i.e. a point of intersection lies on the virtual circle 925 in each of the three arcs created by dividing the virtual circle's perimeter into three equal lengths.

Furthermore, it will be appreciated that, although the elongate flexible members 918 have been described as being polygonal in cross section, the edges of the polygon could be chamfered (as shown in FIG. 20) to increase the area of contact between the elongate flexible members 918 and the object into which the flexible members 918 are inserted.

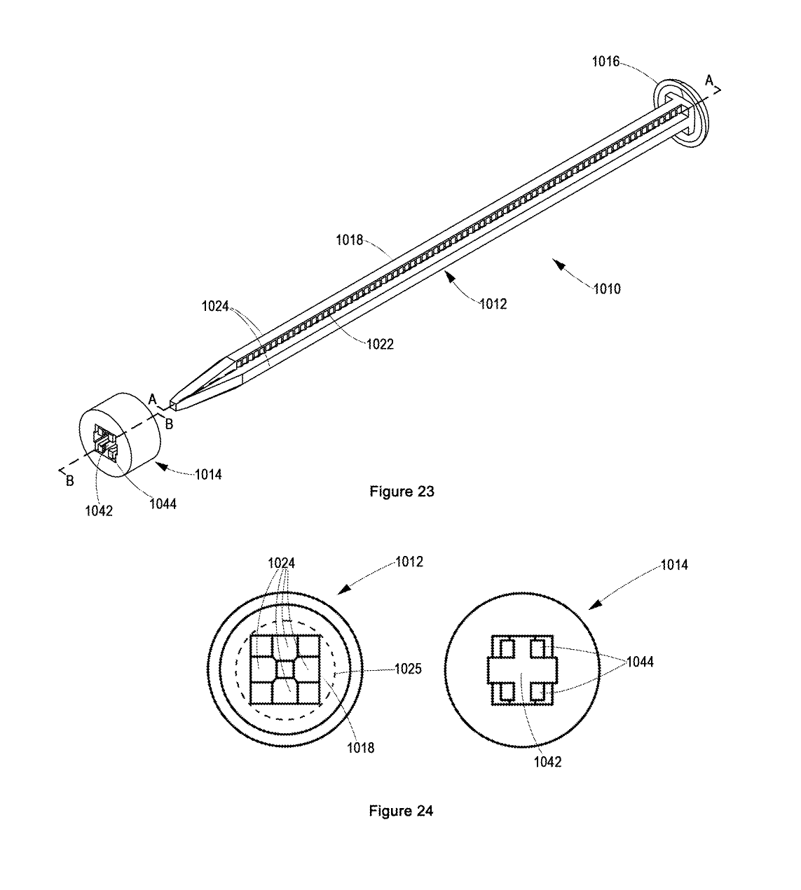

According to a fifteenth embodiment of the two-component fastening system 1010 according to the present invention illustrated in FIGS. 23 and 24. In cross section, the elongate flexible member 1018 of the anchor component 1012 forms a cross (i.e. “X”) with each arm 1024 radiating radially from the axis A-A of the elongate flexible member 1018 and being orthogonal relative to adjacent arms 1024. The elongate flexible member 1018 is tapered, reducing linearly in cross sectional proportions from the head 1016 to the free end of the elongate flexible member 1018.

The push-on fastener component 1014 defines an axially extending bore 1042 that is sized and shaped (i.e. forming a cross in a plane orthogonal to its longitudinal axes B-B) to receive the elongate flexible member 1018 therein and run along the entire length of the elongate flexible member 1018 to the head 1016.

Ratchet formations 1022 and pawls 1044 (as previously described) are included on at least a portion of the surface of at least one arm 1024 of the elongate flexible member 1018 and on the push-on fastener component 1014, respectively.

Importantly, the free ends of the arms 1024 define a virtual circle 1025 that reduces in diameter from the end of the elongate flexible member 1018 adjacent the head 1016 to the free end of the elongate flexible member 1018.

It will be appreciated that although the elongate flexible member 1018 has been described as having four arms, the elongate flexible member 1018 could similarly comprise: (i) three arms uniformly spaced about the longitudinal axis A-A, i.e. radiating from the longitudinal axis A-A at 0 degrees, 120 degrees and 240 degrees; or (ii) five arms radiating from the longitudinal axis A-A at 0 degrees, 60 degrees, 120 degrees, 180 degrees, 240 degrees and 300 degrees.

Furthermore, it will be appreciated that although the head 1016 has previously been described as being fixed to the end of the elongate flexible member 1018, the head (not shown) could be separate from the elongate flexible member 1018 and comprise a second push-on fastener component 1014 that is movable along the elongate flexible member 1018. In this arrangement, the elongate flexible member 1018 would need to include a second array of ratchet formations 1022 co-operating with the head 1016 to permit the head 1016 to move along the elongate flexible member 1018 in one direction, while the array of ratchet formations previously described co-operates with the first push-on fastener 1014 to permit the first push-on fastener to move along the elongate flexible member 1018 in the opposite direction. A benefit of the tapered elongate flexible member 1018 is that it could fit a variety of diameter bores in an object. And, portions of the elongate flexible member 1018 extending beyond the two push-on fastener components could be clipped.

Preferred embodiments include the embodiments shown in FIGS. 19 to 24 and an embodiment in which the elongate flexible member is circular in cross section with a segment removed to provide a linear cord. In each of these preferred embodiments, the elongate flexible member defines a planar surface on which the rachet formations 922 and 1022 are located.

The two-component fastening system 10, as illustrated, provides a relatively cheap fastening system or anchoring system which can, depending on the material of construction, be very strong. The system 10 is quick and easy to use to fasten objects together or to mount an object against a surface or to provide a functional and/or decorative article mounted against a surface. As the strap 18 is flexible, in many instances it will be easier to insert the strap 18 through a passageway, in a desired direction, than it would be to insert an inflexible object such as a bolt. It is advantageously also not necessary for the passageway to be straight, which is necessary when an inflexible elongate member such as a bolt is used, unless the passageway is overly large. As the head of the anchor component, and even the push-on fastening component, can take on virtually any desired shape or configuration only limited by manufacturing practicalities, and as the elongate flexible member can easily be cut or severed to any desired length, the applications of the system 10 as illustrated is virtually limitless.

1. A fastening system including:
an anchor component having:
a head; and
an elongate flexible member extending from the head, the elongate flexible member having:
in section orthogonal to its longitudinal axis one of the following shapes:
(i) a shape wherein at least three equally spaced arms of the same length radiate radially from the longitudinal axis; or
(ii) a polygon made up of linear sections of substantially the same length and at least one groove that extends linearly along the elongate flexible member from the head towards the free end of the elongate flexible member; and
at least one series of longitudinally arranged ratchet formations provided on a planar surface of the elongate flexible member; and
a push-on fastening component which is separate from or, prior to use severable from, the anchor component, the push-on fastening component defining a passageway to receive the elongate flexible member and having at least one ratchet formation engaging member to engage the ratchet formations of the elongate flexible member to allow passage of the elongate flexible member through the passageway in one direction but not in an opposite direction, the push-on fastening component, unlike the anchor component, not including an elongate flexible member with a series of longitudinally arranged ratchet formations.

2. A fastening system according to claim 1, wherein, when the elongate flexible member is in cross-section a polygon, the linear sections of the polygon do not vary in length by more than 15%.

3. A fastening system according to claim 1, wherein, when the elongate flexible member is in cross-section a polygon, the linear sections of the polygon do not vary in length by more than 10%.

4. A fastening system according to claim 1, wherein, when the elongate flexible member is in cross-section a polygon, the linear sections of the polygon do not vary in length by more than 5%.

5. A fastening system according to claim 1, wherein, when the elongate flexible member is in cross-section a polygon, the linear sections of the polygon are of equal length.

6. A fastening system according to claim 1, wherein when the elongate flexible member is in cross-section a polygon, the points of intersection of the linear sections define a virtual circle.

7. A fastening system according to claim 6, wherein at least one point of intersection of the linear sections lies on each of the three arcs created by dividing the virtual circle's perimeter into three equal lengths.

8. A fastening system according to claim 7, wherein the virtual circle has a diameter between 6 mm and 25 mm.

9. A fastening system according to claim 8, wherein the edges of the polygon are chamfered.

10. A fastening system according to claim 9, wherein the at least one series of longitudinally arranged ratchet formations is located within the at least one groove.

11. A fastening system according to claim 1, wherein at least a portion of the head extends radially beyond the radial periphery of the flexible member such that, in use, when the elongate flexible member is inserted through an object passageway extending through one or more objects, the oversized head limits insertion of the anchor component through the passageway.

12. A fastening system according to claim 11, wherein the elongate flexible member is tapered towards its free end.

13. A fastening system according to claim 12, wherein the elongate flexible member is tapered along its entire length.

14. A fastening system according to claim 13, wherein the elongate flexible member includes a second series of longitudinally arranged ratchet formations.

15. A fastening system according to claim 14, wherein the head is separate from the elongate flexible member and the fastening system further includes engaging means for connecting the head to the elongate flexible member.

16. A fastening member according to claim 15, wherein the engaging means comprises a passageway defined by the head to receive the elongate flexible member and at least one ratchet formation engaging member to engage the second series of ratchet formations of the elongate flexible member to allow passage of the elongate flexible member through the passageway in one direction opposite to the permitted direction of movement of the push-on fastening component along the elongate flexible member, but not in the reverse direction.

17. A fastening system according to claim 1, wherein the head: (i) is in the shape of a bolt, screw or similar fastener; or (ii) defines a hook or an eye, a female fastener formation for receiving a male fastener formation, a male fastener formation to be inserted into a female fastener formation, or any other formation on which an object can be supported, from which an object can be suspended, or to which an object can be attached, mounted, fastened or the like.

18. A fastening system according to claim 1, wherein the head includes a body defining a recessed or depressed surface from which the elongate flexible member extends.

19. A fastening system according to claim 18, wherein the body of the head defines an abutment surface or abutment formations abutting in use against an object or a surface against which the head is pulled once the push-on fastening component has been used to fasten the anchor component and the push-on fastening component together, with the elongate flexible member extending between the head and the push-on fastening component being under tension.

20. A fastening system according to claim 19, wherein the abutment surface or abutment formations surround the elongate flexible member where the elongate flexible member extends from the head.

21. A fastening system according to claim 20, wherein the abutment surface is peripheral, planar and endless.

22. A fastening system according to claim 20, wherein the abutment formations are equiangularly spaced about the elongate flexible member.

23. A fastening system according to claim 1, wherein the elongate flexible member includes two series of ratchet formations respectively arranged on opposed sides of the elongate flexible member.

24. A fastening system according to claim 1, wherein the at least one ratchet formation engaging member is in the form of a pawl positioned to engage the ratchet formations of the elongate flexible member.

25. A fastening system according to claim 24, wherein the anchor component and the push-on fastening component are integrally moulded together from a synthetic plastics or polymeric material and divided by a frangible line.

26. A fastening system according to claim 1, wherein the push-on fastening component includes a body that defines an abutment surface or abutment formations abutting in use against a surface or object from which the elongate flexible member of the anchor component projects, once the push-on fastening component has been used to fasten the anchor component and the push-on fastening component together, with the elongate flexible member being under tension.

27. A fastening system according to claim 26, wherein the abutment surface or abutment formations surround the passageway of the push-on or second fastening component.

28. A fastening system according to claim 27, wherein the abutment surface on the body of the push-on fastening component is peripheral, planar and endless.

29. A fastening system according to claim 27, wherein the abutment formations on the body of the push-on fastening component are equiangularly spaced about the passageway of the push-on fastening component.

30. A fastening system according to claim 29, wherein the body of the push-on fastening component defines a recessed or depressed surface, surrounded by the abutment surface or the abutment formations of the body of the push-on fastening component, with the passageway of the push-on fastening component opening out in the recessed or depressed surface.
